(19) United States
(12) Patent Application Publication
(10) Pub. No.: US 2021/0272718 A1
(43) Pub. Date: Sep. 2, 2021

(54) HYBRID WIRELINE METHODS AND APPARATUS

(71) Applicant: FORUM US, INC., Houston, TX (US)

(72) Inventors: Erling VANAR, Calgary (CA); Raymond G. FUNKE, Okotoks (CA); Gregory William MACTAVISH, Calgary (CA)

(21) Appl. No.: 16/804,836

(22) Filed: Feb. 28, 2020

(51) Int. Cl. H01B 7/02; H01B 1/12; H01B 11/10; H01B 3/42

(52) U.S. Cl. CPC H01B 7/0216; H01B 3/426; H01B 11/1058; H01B 1/124

(57) ABSTRACT

Aspects of the disclosure relate to methods of forming and using hybrid wirelines, and associated apparatus thereof. The method is configured to form a hybrid wireline cable that comprises a core having a conductive strand and an insulation layer disposed around the conductive strand. A first plurality of solid wires are disposed around the core to form an inner armor layer. A combination of a first plurality of stranded wires and a second plurality of solid wires are disposed around the inner armor layer to form an outer armor layer. A jacket is disposed around the inner armor layer and the outer armor layer.

### BACKGROUND

### Field

Aspects of the disclosure relate to methods of forming and using hybrid wirelines, and associated apparatus thereof. In one example, the hybrid wirelines are used in wireline operations in relation to oil and gas wells.

### Description of the Related Art

Downhole equipment is often lowered from the surface into a wellbore of an oil and gas well using one or more wirelines, which are electrical cables used to transmit power and/or data to and from the downhole equipment. When a wireline is lowered into a wellbore that is filled with fluids, buoyancy of the wireline and/or downhole equipment supported by the wireline can reduce or eliminate tension in wireline. Reduced or eliminated tension can cause the wireline to buckle or undergo torqueing forces such that portions of the wireline twist apart, peel apart, or de-laminate, which often requires replacement of the wireline and thereby increases time and cost of wireline operations.

Therefore, there is a need for new and/or improved wireline methods and apparatus.

### SUMMARY

Aspects of the disclosure relate to methods of forming and using hybrid wirelines, and associated apparatus thereof. In one example, the hybrid wirelines are used in wireline operations in relation to oil and gas wells.

In one implementation, a method of forming a hybrid wireline cable comprises providing a core, the core comprising conductive strands and one or more layers of insulation disposed around the conductive strands; stranding a first plurality of solid wires around the core of the conductive strands and the one or more layers of insulation to form an inner armor layer; stranding a first plurality of stranded wires and a second plurality of solid wires around the inner armor layer in a single pass using a single preform head to form an outer armor layer; and disposing a jacket around the inner armor layer and the outer armor layer.

In one implementation, a method of forming a hybrid wireline cable comprises running a core through a preform head, the core comprising: a plurality of conductive strands; one or more layers of insulation disposed around the plurality of conductive strands; and a first plurality of solid wires disposed around the plurality of conductive strands and the one or more layers of insulation to form an inner armor layer; running a stranded wire of a first plurality of stranded wires through a first set of rollers coupled to the preform head; running a solid wire of a second plurality of solid wires through a second set of rollers coupled to the preform head, wherein one of the first set of rollers or the second set of rollers comprises an offset roller; stranding the first plurality of stranded wires and the second plurality of solid wires around the inner armor layer to form an outer armor layer; and disposing a jacket around the inner armor layer and the outer armor layer.

In one implementation, a method of forming a hybrid wireline cable comprises running a core through a preform head, the core comprising: a plurality of conductive strands; one or more layers of insulation disposed around the plurality of conductive strands; and a first plurality of solid wires disposed around the plurality of conductive strands and the one or more layers of insulation to form an inner armor layer; running a stranded wire of a first plurality of stranded wires through a first set of rollers coupled to the preform head, each of the first set of rollers comprising a groove formed therein receiving the stranded wire and having a first diameter; running a solid wire of a second plurality of solid wires through a second set of rollers coupled to the preform head, each of the second set of rollers comprising a groove formed therein receiving the solid wire and having a second diameter that is different than the first diameter; stranding the first plurality of stranded wires and the second plurality of solid wires around the inner armor layer to form an outer armor layer; and disposing a jacket around the inner armor layer and the outer armor layer.

### BRIEF DESCRIPTION OF THE DRAWINGS

So that the manner in which the above-recited features of the disclosure can be understood in detail, a more particular description of the disclosure, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1 illustrates a partial schematic cross-sectional view of a wireline cable, according to one implementation.

FIG. 2A illustrates a partial schematic isometric view of a preform head and first and second sets of rollers, according to one implementation.

FIG. 2B illustrates an enlarged partial schematic view of the preform head and the first and second sets of rollers illustrated in FIG. 2A, according to one implementation.

FIG. 3A illustrates an enlarged partial schematic view of the preform head and the second sets of rollers illustrated in FIGS. 2A and 2B, with offset sets of rollers, according to one implementation.

FIG. 3B illustrates an enlarged partial schematic view of the preform head and the first sets of rollers illustrated in FIGS. 2A and 2B, with offset sets of rollers, according to one implementation.

FIG. 4 illustrates a partial schematic view of a first roller as part of a first roller assembly and a second roller as part of a second roller assembly, according to one implementation.

FIG. 5 illustrates a schematic view of a method of forming a wireline cable, according to one implementation.

FIG. 6 is a schematic view of the wireline cable illustrated in FIG. 1 being used to lower a tool into a wellbore of an oil and gas well, according to one implementation.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Aspects of the disclosure relate to methods of forming and using hybrid wirelines, and associated apparatus thereof. In one example, the hybrid wirelines are used in wireline operations in relation to oil and gas wells.

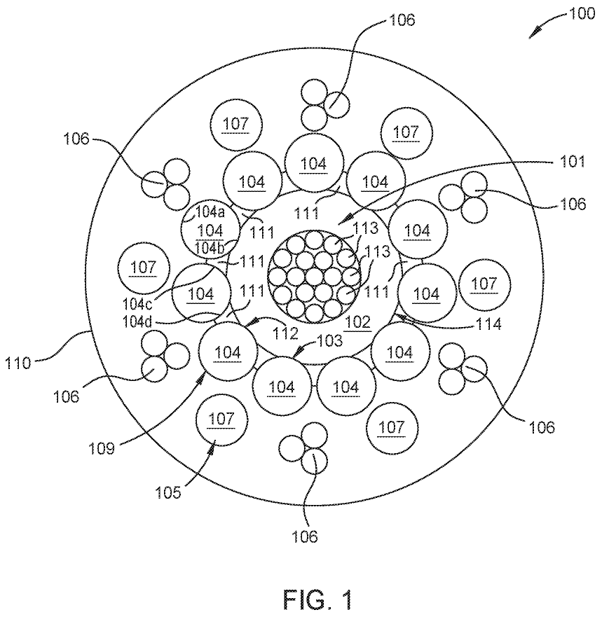

FIG. 1 illustrates a partial schematic cross-sectional view of a wireline cable 100, according to one implementation. The wireline cable 100 includes a core 101. The core 101 includes conductive strands 113. In one example, the core 101 includes nineteen conductive strands 113, as illustrated in FIG. 1. One or more electrical signals may be communicated through the conductive strands 113 to a tool supported on an end of the wireline cable 100. The tool may be an oil and gas tool, such as a packer and/or a perforation gun. In one example, one or more electrical signals may be communicated through the conductive strands 113 to activate the packer and/or the perforation gun. The tool may be suspended from the wireline cable 100. The wireline cable 100 is used to lower the tool into a wellbore of an oil and gas well. The conductive strands 113 include a first metal. In one example, the first metal includes a conductive metal, such as copper. The wireline cable 100 is an electromechanical oilfield wireline cable.

The core 101 also includes one or more layers of insulation 102 disposed around the conductive strands 113. In one example, the one or more layers of insulation 102 include one layer of insulation disposed around the conductive strands 113, as illustrated in FIG. 1. In one example, the one or more layers of insulation 102 include a first layer of insulation disposed around the conductive strands 113 and a second layer of insulation disposed around the first layer of insulation. The one or more layers of insulation 102 may be disposed around the conductive strands 113 using application methods such as extrusion and/or spray-coating. The one or more layers of insulation 102 include one or more electrical insulation materials, such as fluorinated ethylene propylene (FEP) and ethylene tetrafluoroethylene (ETFE).

The wireline cable 100 includes an inner armor layer 103 and an outer armor layer 105 disposed outside of the inner armor layer 103. The inner armor layer 103 includes a first plurality of solid wires 104 stranded around an outer circumference 114 of the core 101 in a helical pattern. In one example, the inner armor layer 103 includes eleven solid wires 104. The outer armor layer 105 includes a first plurality of stranded wires 106 and a second plurality of solid wires 107 stranded around an outer circumference 109 of the inner armor layer 103 in a helical pattern. In one example, the outer armor layer 105 includes six solid wires 107 and six stranded wires 106.

The first plurality of stranded wires 106 and the second plurality of solid wires 107 of the outer armor layer 105 are stranded around the inner armor layer 103 in an alternating arrangement. According to the alternating arrangement, each stranded wire 106 is disposed between two solid wires 107, and each solid wire 107 is disposed between two stranded wires 106, as illustrated in FIG. 1. The first plurality of solid wires 104, the first plurality of stranded wires 106, and the second plurality of solid wires 107 include a second metal. The second metal is a high-strength metal, such as galvanized steel.

The wireline cable 100 includes a jacket 110 disposed around the inner armor layer 103 and the outer armor layer 105. The jacket 110 may be disposed using application methods such as extrusion. The jacket 110 completely surrounds the stranded wires 106 and the solid wires 107 of the outer armor layer 105. The jacket 110 partially surrounds the solid wires 104 of the inner armor layer 103 such that a first portion 104a of each solid wire 104 is in contact with the jacket 110, and a second portion 104b is not in contact with the jacket 110. The jacket 110 includes a polymeric material, such as a carbon fiber filled ethylene tetrafluoroethylene (CF-ETFE). One or more interstitial voids 111 are formed adjacent an inner circumference 112 of the inner armor layer 103. The one or more interstitial voids 111 are disposed between two adjacent solid wires 104 of the inner armor layer 103. The one or more interstitial voids 111 are also disposed between the jacket 110 and the one or more layers of insulation 102 of the core 101. Each interstitial void 111 is bounded by a portion of the jacket 110 on a first side, a portion of the one or more layers of insulation 102 on a second side, and two solid wires 104 of the first plurality of solid wires 104 on a third side and a fourth side. The one or more interstitial voids 111 include air or an empty space such that a third portion 104c and a fourth portion 104d of the solid wires 104 are in contact with air or an empty space.

The outer armor layer 105 is a hybrid layer including both the solid wires 107 and the stranded wires 106. Each stranded wires 106 includes three strands. In one example, the jacket 110 is mechanically adhered to the outer armor layer 105 and the inner armor layer 103, for example by gluing the jacket 110 to the outer armor layer 105 and the inner armor layer 103. The stranded wires 106 of the outer armor layer 105 facilitate mechanical adhesion of the jacket 110. Using multiple strands in the stranded wires 106 provides increased outer surface area of the stranded wires 106 to which the jacket 110 may bond, facilitating mechanical adhesion of the jacket 110 to the stranded wires 106. Stranded wires 106 having an overall outer diameter provide increased outer surface area relative to solid wires 107 having an outer diameter similar to the overall outer diameter of the stranded wires 106.

The combination of both solid wires 107 (which are more rigid than stranded wires) and stranded wires 106 (which are more flexible than solid wires) in the hybrid outer armor layer 105 allows the wireline cable 100 to undergo torqueing caused by buoyancy during wireline operations with reduced or eliminated twisting, peeling, or de-lamination of portions such as the jacket 110, the solid wires 104, 107 and/or the stranded wires 106 of the wireline cable 100 apart from other portions of the wireline cable 100. The hybrid outer armor layer 105 provides a balance of flexible properties and rigid properties to the wireline cable 100, which increases the operational lifespan of the wireline cable 100 as compared to wireline cables formed of completely solid wires or completely stranded wires when subject to a variety of operational conditions. Such operational conditions include torqueing of the wireline cable 100 caused by high buoyancy forces during wireline operations while the wireline cable 100 is disposed in a wellbore of an oil and gas well.

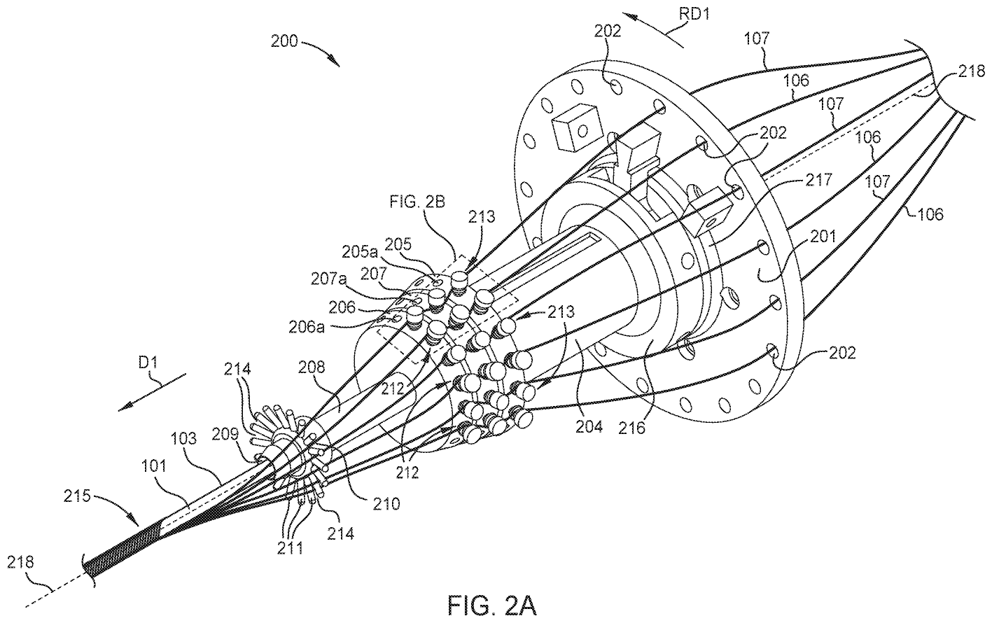

FIG. 2A illustrates a partial schematic isometric view of a preform head 200 and first and second sets of rollers 212, 213, according to one implementation. The preform head 200 may be used to form the outer armor layer 105 illustrated in FIG. 1. The preform head 200 includes an end plate 201 having wire openings 202 formed through the end plate 201 in a circumferential pattern. The preform head 200 includes a first shaft 204 that extends from the end plate 201. Adjacent an end of the first shaft 204 the preform head 200 includes a first plate 205, a second plate 206, and a third plate 207. The third plate 207 is disposed between the first plate 205 and the second plate 206, as illustrated in FIG. 2A. Each of the plates 205, 206, 207 include a plurality of openings 205a, 206a, 207a, formed in the respective plate 205, 206, or 207. The preform head 200 includes a second shaft 208 that at least partially extends from the second plate 206 in a direction away from the end plate 201. The second shaft 208 includes a central opening 209 formed in the second shaft 208. The preform head 200 includes a wire guide 210. The wire guide 210 includes a plurality of guide members 211 that extend outward from the wire guide 210 in a direction radially outward from the second shaft 208. The preform head 200 includes a central longitudinal axis 218 that extends longitudinally through a center of the preform head 200 and a center of the central opening 209. As an example, the central longitudinal axis 218 may extend through a center of the circular shape of the end plate 201 and a center of the circular shape of the central opening 209.

The first shaft 204 may be coupled to the end plate 201. As an example, a round portion 216 of the first shaft 204 may be coupled to a round portion 217 that protrudes from an outer surface of the end plate 201. One or more of the first plate 205, the second plate 206, and/or third plate 207 may be coupled to each other or the end plate 201. The second shaft 208 may be coupled to the first plate 205, the second plate 206, the third plate 207, the shaft 204, and/or the end plate 201. The wire guide 210 may be coupled to the second shaft 208.

The core 101 (having the conductive strands 113 and the one or more layers of insulation 102) and the inner armor layer 103 formed around the core 101 are longitudinally passed through the preform head 200 and through the central opening 209 in a linear direction. In one example, the solid wires 104 of the inner armor layer 103 are stranded around the core 101 using a second preform head prior to the core 101 entering the preform head 200. The second preform head may be used to form the inner armor layer 103, while the preform head 200 is used to form the outer armor layer 105. In one example, the preform head 200 may be used to form the inner armor layer 103 with rollers that are sized and shaped for the inner armor layer 103, and then the core 101 with the inner armor layer 103 may be re-run through the preform head 200 with different rollers sized and shaped for the outer armor layer 105 to form the outer armor layer 105.

The preform head 200 is illustrated in FIG. 2A as stranding the first plurality of stranded wires 106 and the second plurality of solid wires 107 around the inner armor layer 103 and the core 101 as the inner armor layer 103 and the core 101 are ran through the preform head 200 and the central opening 209. The wires of the first plurality of stranded wires 106 and the second plurality of solid wires 107 are ran through the wire openings 202 of the end plate 201 in an alternating arrangement. According to the alternating arrangement, each stranded wire 106 is disposed between two adjacent solid wires 107 and each solid wire 107 is disposed between two adjacent stranded wires 106 around the circumference of the end plate 201.

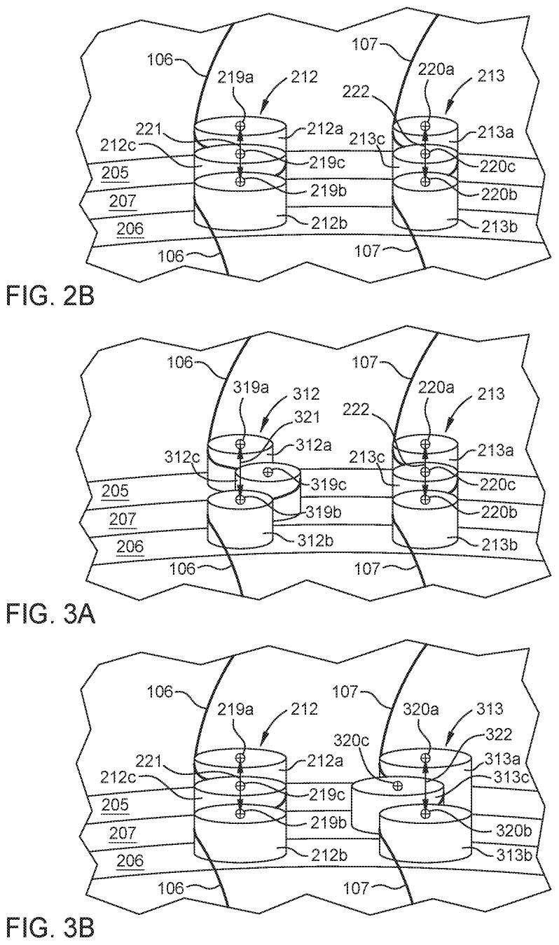

Each stranded wire 106 is ran through a respective first set of rollers 212 that preform the stranded wire 106. Each solid wire 107 is ran through a respective second set of rollers 213 that preform the solid wire 107. Each roller of the first sets of rollers 212 and the second sets of rollers 213 is part of a roller assembly, as discussed below in relation to FIG. 3. Each roller of the first and second sets of rollers 212, 213 is coupled to a corresponding opening 205a, 206a, 207a of the first, second, or third plate 205, 206, 207 of the preform head 200. After running through a respective first set of rollers 212 or a respective second set of rollers 213, each wire of the solid wires 107 and the stranded wires 106 is ran through a respective opening 214 disposed between two adjacent guide members 211 of the wire guide 210.

For clarity, FIG. 2A schematically illustrates portions of the stranded wires 106, the solid wires 107, and the first and second sets of rollers 212, 213. The present disclosure contemplates that first and second sets of rollers 212, 213 may be disposed about the entirety of the circumference of each first, second, and third plate 205, 206, 207. The present disclosure contemplates that each wire opening 202 disposed about the entire circumference of the end plate 201 may include a corresponding solid wire 107 or stranded wire 106 ran therethrough.

As the core 101 having the inner armor layer 103 thereon is ran through the preform head 200 and the central opening 209 in a longitudinal direction D1, the stranded wires 106 and the solid wires 107 are ran through the wire openings 202, the first and set sets of rollers 212, 213, and the openings 214 between the guide members 211. As the core 101 having the inner armor layer 103, the first plurality of stranded wires 106, and the second plurality of solid wires 107 are being run through, the preform head 200 is rotated in a rotational direction RD1 to strand the solid wires 107 and the stranded wires 106 around the outer circumference 109 of the inner armor layer 103 to form the outer armor layer 105. The first plurality of stranded wires 106 and the second plurality of solid wires 107 are stranded around the core 101 and the inner armor layer 103 at or near a location 215 that is downstream from the second shaft 208 of the preform head 200 in the longitudinal direction D1. Rotation of the preform head 200 in the rotational direction RD1 includes rotation of the end plate 201, the first shaft 204, the first plate 205, the second plate 206, the third plate 207, the second shaft 208, the wire guide 210, and the guide members 211 in the rotational direction RD1. The rotation of the preform head 200 and the portions thereof facilitates stranding the solid wires 107 and the stranded wires 106 around the inner armor layer 103 in a helical pattern to form the outer armor layer 105.

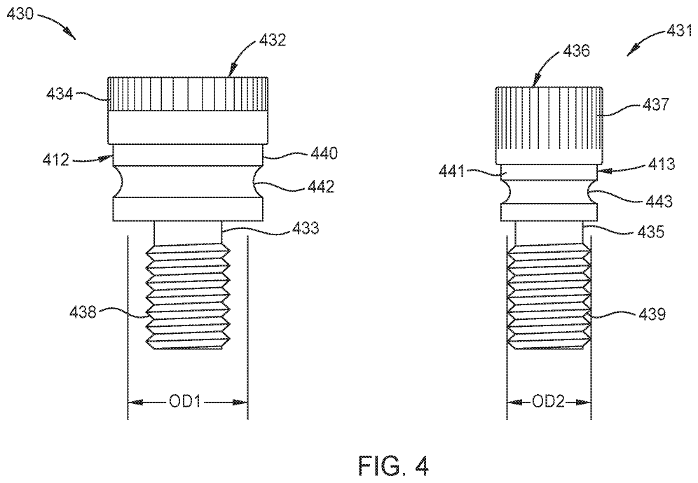

FIG. 2B illustrates an enlarged partial schematic view of the preform head 200 and the first and second sets of rollers 212, 213 illustrated in FIG. 2A, according to one implementation. Each roller of the first and second set of rollers 212, 213 is a part of a roller assembly (discussed below in relation to FIG. 4) that couples the rollers 212, 213 to the first, second, or third plate 205-207 of the preform head 200. The first set of rollers 212 includes a first roller 212a coupled to the first plate 205, a second roller 212b coupled to the second plate 206, and a third roller 212c coupled to the third plate 207. The rollers 212a-212c are cylindrical in shape and each include a center 219a-219c. The second set of rollers 213 includes a first roller 213a coupled to the first plate 205, a second roller 213b coupled to the second plate 206, and a third roller 213c coupled to the third plate 207. The rollers 213a-213c are cylindrical in shape and each include a center 220a-220c.

The first set of rollers 212 are in-line such the center 219c of the third roller 212c falls within and is in-line with a linear direction 221 extending between the center 219a of the first roller 212a and the center 219b of the second roller 212b. The linear direction 221 may be parallel to the central longitudinal axis 218 of the preform head 200 and the longitudinal direction D1. The second set of rollers 213 are in-line such the center 220c of the third roller 213c falls within and is in-line with a linear direction 222 extending between the center 220a of the first roller 213a and the center 220b of the second roller 213b. The linear direction 222 may be parallel to the central longitudinal axis 218 of the preform head 200 and the longitudinal direction D1. Each roller 212a-212c is sized to preform stranded wire as the stranded wire 106 is run through the first set of rollers 212. Each roller 213a-213c is sized to preform solid wire as the solid wire 107 is run through the second set of rollers 213.

A size of each roller 212a-212c of the first set of rollers 212 is larger than a size of each roller 213a-213c of the second set of rollers 213. For example, the outer diameter of each roller 212a-212c of the first set of rollers 212 is larger than the outer diameter of each roller 213a-213c of the second set of rollers 213. The size of each roller 213a-213c of the second set of rollers 213 is less than the size of each roller 212a-212c of the first set of rollers 212. For example, the outer diameter of each roller 213a-213c of the second set of rollers 213 is less than the outer diameter of each roller 212a-212c of the first set of rollers 212.

The size of the second set of rollers 213 is a ratio of the size of the first set of rollers 212. In one example, the ratio is within a range of 0.6 to 0.8 of the size of the first set of rollers. The differing size of the first set of rollers 212 and the second set of rollers 213 facilitates forming the hybrid outer armor layer 105 that includes both solid wires 107 and stranded wires 106. The differing size facilitates achieving a preform for the solid wires 107 that is 60 percent to 80 percent of a preform for the stranded wires 106.

The differing number of strands between the solid wires 107, on one hand, and the stranded wires 106, on the other hand, can disrupt the helical pattern when stranding the solid wires 107 and the stranded wires 106 are stranded simultaneously in a single pass. As an example, the solid wires 107 form a helix of the same diameter more readily than the stranded wires 106. However, the differing size of the first sets of rollers 212 and the second sets of rollers 213 facilitates maintaining the helical pattern while stranding the solid wires 107 and the stranded wires 106 simultaneously in a single pass using the single preform head 200 to create the hybrid outer armor layer 105. Stranding to form the hybrid outer armor layer 105 in a single pass using the single preform head 200 facilitates increased efficiency, time savings, and cost savings while facilitating formation of a durable wireline cable 100 having increased operational lifespans.

FIG. 3A illustrates an enlarged partial schematic view of the preform head 200 and the second sets of rollers 213 illustrated in FIGS. 2A and 2B, with offset sets of rollers 312, according to one implementation. Each first set of rollers 212 illustrated in FIGS. 2A and 2B are replaced with an offset set of rollers 312. The offset set of rollers 312 includes a first roller 312a, a second roller 312b, and an offset roller 312c. The second roller 312b is in-line with the first roller 312a such that a linear direction 321 extends between a center 319a of the first roller 312a and a center 319b of the second roller 312b. The offset roller 312c is offset from the first roller 312a and the second roller 312b such that a center 319c of the offset roller 312c is offset from the linear direction 321 and disposed at a distance from the linear direction 321. The linear direction 321 may be parallel to the central longitudinal axis 218 of the preform head 200 and the longitudinal direction D1.

The offset roller 312c of each one of the sets of offset rollers 312 may be offset from the first and second rollers 312a, 312b by installing the first and second rollers 312a, 312b on openings 205a, 206a of the first and second plates 205, 206 that are aligned, and installing the offset roller 312c on an opening 207a of the third plate 207 that is offset from the openings 205a, 206a of the first and second rollers 312a, 312b. The opening 207a may be offset when the openings 205a-207a are formed in the respective plates 205-207.

In one implementation, which can be combined with other implementations, the offset roller 312c is offset from the first roller 312a and the second roller 312b by an offset angle. The offset angle is measured relative to the central longitudinal axis 218. In one example, the offset angle is within a range of 1 degree to 30 degrees, such as 1 degree to 15 degrees, or such as 1 degree to 9 degrees.

Each roller 312a-312c of the offset set of rollers 312 and each roller 213a-213c of the second set of rollers 213 are the same size. Each roller 312a-312c of the offset set of rollers 312 and each roller 213a-213c of the second set of rollers 213 is sized to preform solid wire, yet the stranded wires 106 are ran through the offset sets of rollers 312 and the solid wires 107 are ran through the second sets of rollers 213. The offset roller 312c facilitates achieving a helical pattern of the outer armor layer 105 that has a helix of 70 percent to 85 percent. The offset roller 312c facilitates achieving a preform for the solid wires 107 that is 60 percent to 80 percent of a preform for the stranded wires 106. The offset roller 312c facilitates maintaining the helical pattern of the outer armor layer 105 while stranding the solid wires 107 and the stranded wires 106 onto the core 101 simultaneously in a single pass using the single preform head 200, even though the offset set of rollers 312 are sized to preform solid wire. Stranding to form the hybrid outer armor layer 105 in a single pass using a single preform head 200 facilitates increased efficiency, time savings, and cost savings while facilitating formation of a durable wireline cable 100 having increased operational lifespans. The ability to simultaneously strand both the stranded wires 106 and the solid wires 107 simultaneously using rollers 312a-312c and 213a-213c of the same size facilitates increased efficiency, time savings, and cost savings.

FIG. 3B illustrates an enlarged partial schematic view of the preform head 200 and the first sets of rollers 212 illustrated in FIGS. 2A and 2B, with offset sets of rollers 313, according to one implementation. Each second set of rollers 213 illustrated in FIGS. 2A and 2B are replaced with an offset set of rollers 313. The offset set of rollers 313 includes a first roller 313a, a second roller 313b, and an offset roller 313c. The second roller 313b is in-line with the first roller 313a such that a linear direction 322 extends between a center 320a of the first roller 313a and a center 320b of the second roller 313b. The offset roller 313c is offset from the first roller 313a and the second roller 313b such that a center 320c of the offset roller 313c is offset from the linear direction 322 and disposed at a distance from the linear direction 322. The linear direction 322 is parallel to the central longitudinal axis 218 of the preform head 200 and the longitudinal direction D1.

The offset roller 313c of each one of the sets of offset rollers 313 may be offset from the first and second rollers 313a, 313b by installing the first and second rollers 313a, 313b on openings 205a, 206a of the first and second plates 205, 206 that are aligned, and installing the offset roller 313c on an opening 207a of the third plate 207 that is offset from the openings 205a, 206a of the first and second rollers 313a, 313b. The opening 207a may be offset when the openings 205a-207a are formed in the respective plates 205-207.

In one implementation, which can be combined with other implementations, the offset roller 313c is offset from the first roller 313a and the second roller 313b by an offset angle. The offset angle is measured relative to the central longitudinal axis 218. In one example, the offset angle is within a range of 1 degree to 30 degrees, such as 1 degree to 15 degrees, or such as 1 degree to 9 degrees.

Each roller 313a-313c of the offset set of rollers 313 and each roller 212a-212c of the first set of rollers 212 are the same size. Each roller 313a-313c of the offset set of rollers 313 and each roller 212a-212c of the first set of rollers 212 is sized to preform stranded wire, yet the solid wires 107 are ran through the offset sets of rollers 313 and the stranded wires 106 are ran through the first sets of rollers 212. The offset roller 313c facilitates achieving a helical pattern of the outer armor layer 105 that has a helix of 70 percent to 85 percent. The offset roller 313c facilitates achieving a preform for the solid wires 107 that is 60 percent to 80 percent of a preform for the stranded wires 106. The offset roller 313c facilitates maintaining the helical pattern of the outer armor layer 105 while stranding the solid wires 107 and the stranded wires 106 onto the core 101 simultaneously in a single pass using the single preform head 200, even though the offset set of rollers 313 are sized to preform stranded wire. Stranding to form the hybrid outer armor layer 105 in a single pass using the single preform head 200 facilitates increased efficiency, time savings, and cost savings while facilitating formation of a durable wireline cable 100 having increased operational lifespans. The ability to simultaneously strand both the stranded wires 106 and the solid wires 107 simultaneously using rollers 313a-313c and 212a-212c of the same size facilitates increased efficiency, time savings, and cost savings.

FIG. 4 illustrates a partial schematic view of a first roller 412 as part of a first roller assembly 430 and a second roller 413 as part of a second roller assembly 431, according to one implementation. The first roller 412 and the second roller 413 are cylindrical in shape. The first roller 412 is disposed about a non-threaded portion of a shank 433 of a first fastener 432 and abuts against a head 434 of the first fastener 432. The second roller 413 is disposed about a non-threaded portion of a shank 435 of a second fastener 436 and abuts against a head 437 of the second fastener 436. The heads 434, 437 include a socket formed therein for installing and removing the fasteners 432, 436 into and from the openings 205a-207a of the plates 205-207. Each roller 412, 413 includes a central opening for disposition of the respective shank 433, 435 therethrough. Each shank 433, 435 of the first and second fasteners 432, 436 includes a threaded portion 438, 439. The threaded portions 438, 439 of the first and second fasteners 432, 436 is configured to thread into a threaded portion of one of the openings 205a-207a of the first, second, or third plates 205, 206, 207 to couple the respective first or second roller 412 or 413 to the respective first, second, or third plate 205, 206, 207. Each of the fasteners 432, 436 may include a fastener such as a bolt, a screw, or a pin.

The first roller 412 includes an outer circumferential surface 440 and the second roller 413 includes an outer circumferential surface 441. The first roller 412 includes a first groove 442 formed in the outer circumferential surface 440 and the second roller 413 includes a second groove 443 formed in the outer circumferential surface 441. The first and second grooves 442, 443 are configured to receive wire (such as the solid wire 107 and/or the stranded wire 106) as the wire is ran along the rollers 412, 413.

The first roller 412 is sized to preform stranded wires and the second roller 413 is sized to preform solid wires. The first roller 412 includes a size that is larger than a size of the second roller. The first groove 442 of the first roller 412 defines a first diameter OD1 that is lesser than an outer diameter of the outer circumferential surface 440 of the first roller 412. The second groove 443 of the second roller 413 defines a second diameter OD2 that is lesser than an outer diameter of the outer circumferential surface 441 of the second roller 413. The first diameter OD1 is larger than the second diameter OD2. The second diameter OD2 is a ratio of the first diameter OD1. In one example, the ratio is within a range of 0.6 to 0.8 of the first diameter OD1. In one example, the first diameter OD1 is within a range of 0.5 inches to 0.75 inches and the second diameter OD2 is within a range of 0.25 inches to 0.5 inches. In one implementation, which can be combined with other implementations, each of the first and second rollers 412, 413 includes an inner race of a bearing. The first and second rollers 412, 413 may be rods. The first and second rollers 412, 413 include a hard material, such as steel or a ceramic.

The present disclosure contemplates that the first roller 412, as part of the first roller assembly 430, may be used as each of the first, second, and third rollers 212a-212c of the first set of rollers 212 (as described for FIGS. 2A, 2B, and 3B) and/or as each of the first, second, and offset rollers 313a-313c of the offset set of rollers 313 (as described for FIG. 3B). The present disclosure also contemplates that the second roller 413, as part of the second roller assembly 431, may be used as each of the first, second, and third rollers 213a-213c of the second set of rollers 213 (as described for FIGS. 2A, 2B, and 3A) and/or as each of the first, second, and offset rollers 312a-312c of the offset set of rollers 312 (as described for FIG. 3A).

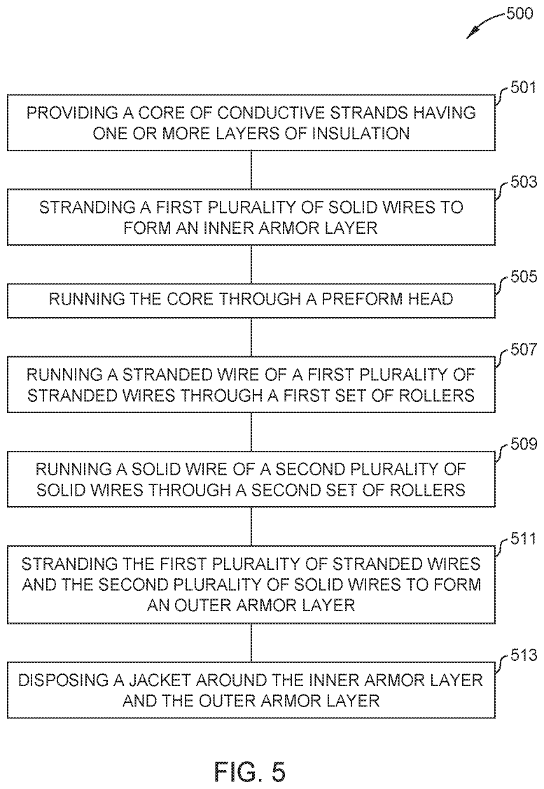

FIG. 5 illustrates a schematic view of a method 500 of forming a wireline cable, according to one implementation. Block 501 includes providing a core having conductive strands and one or more layers of insulation disposed around the conductive strands. In one example, the providing the core at block 501 includes stranding the conductive strands together and disposing the one or more layers of insulation around the conductive strands. Block 503 includes stranding a first plurality of solid wires around the core of the conductive strands and the one or more layers of insulation in a helical pattern to form an inner armor layer around the one or more layers of insulation. Block 505 includes running the core, which has the inner armor layer, through a central opening of a preform head. The preform head in block 505 may have been used to strand the first plurality of solid wires at block 503. Block 507 includes running a stranded wire of a first plurality of stranded wires through a first set of rollers. Block 509 includes running a solid wire of a second plurality of solid wires through a second set of rollers. Block 511 includes stranding the first plurality of stranded wires and the second plurality of solid wires around an outer circumference of the inner armor layer in a helical pattern to form an outer armor layer. The first plurality of stranded wires and the second plurality of solid wires are simultaneously preformed by the respective sets of rollers and are simultaneously stranded around the outer circumference of the inner armor layer in a helical pattern to form the outer armor layer. Block 513 includes disposing a jacket around the inner armor layer and the outer armor layer.

The present disclosure contemplates that the wireline cable 100 described in relation to FIG. 1 may be formed using the apparatus and/or the methods described above, such as the preform head 200 described in relation to FIGS. 2A-2B and 3A-3B; the sets of rollers 212-213 and 312-313 described in relation to FIGS. 2A-2B and 3A-3B; the roller assemblies 430, 431 described in relation to FIG. 4; and/or the method 500 described in relation to FIG. 5.

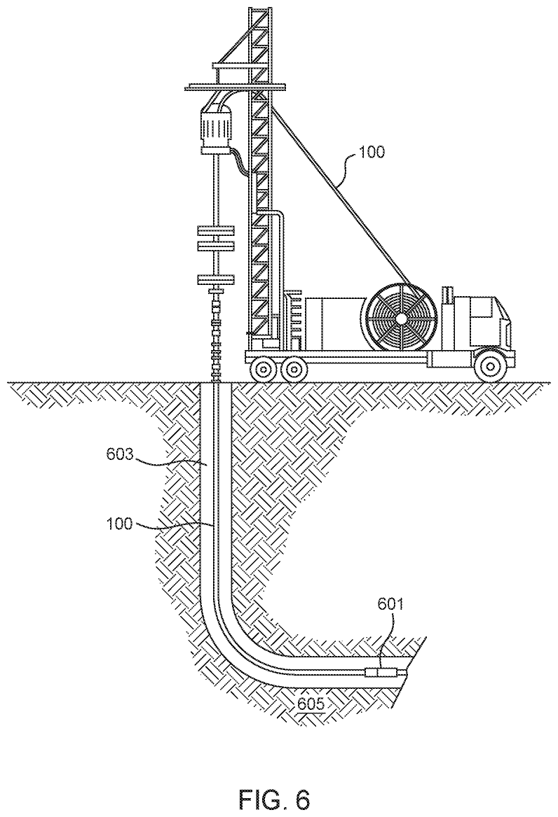

FIG. 6 is a schematic view of the wireline cable 100 illustrated in FIG. 1 being used to lower a tool 601 into a wellbore 603 of an oil and gas well 605, according to one implementation. The tool 601 may be an oil and gas tool, such as a packer and/or a perforation gun. One or more electrical signals may be communicated through the wireline cable 100 to activate the tool 601.

Benefits of the present disclosure include forming a hybrid outer armor layer simultaneously and in a single pass using a single preform head; forming an inner armor layer and a hybrid outer armor layer simultaneously and in a single pass; forming a wireline cable that is durable; facilitating longer operational lifespans for wireline cables; forming wireline cables that can undergo buoyancy in a variety of wireline operational conditions with reduced or eliminated buckling or torqueing of the wireline cables; forming wireline cables that can undergo buoyancy in a variety of wireline operational conditions with reduced or eliminated peeling, twist-off, separation, and de-lamination of portions of the wireline cables; and increased efficiency, time savings, and cost savings.

Aspects of the present disclosure include stranding solid wires and stranded wires simultaneously in a single pass using a single preform head to form a hybrid outer armor layer; running stranded wires through first sets of rollers sized to preform stranded wires and running solid wires through second sets of rollers sized to preform stranded wires, each of the second sets of rollers including an offset roller; running stranded wires through first sets of rollers sized to preform solid wires and running solid wires through second sets of rollers sized to preform solid wires, each of the first sets of rollers including an offset roller; running stranded wires through first sets of rollers having a first size and running solid wires through second sets of rollers having a second size, the first size being larger than the second size. It is contemplated that one or more of the aspects disclosed herein may be combined. Moreover, it is contemplated that one or more of these aspects may include some or all of the aforementioned benefits.

The present disclosure contemplates that terms such as “couples,” “coupling,” “couple,” and “coupled” may include welding, interference fitting, and/or fastening such as by using bolts, threaded connections, and/or screws. The present disclosure contemplates that terms such as “couples,” “coupling,” “couple,” and “coupled” may include direct coupling and/or indirect coupling.

It will be appreciated by those skilled in the art that the preceding implementations are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The present disclosure also contemplates that one or more aspects of the implementations described herein may be substituted in for one or more of the other aspects described. The scope of the disclosure is determined by the claims that follow.

We claim:

1. A method of forming a hybrid wireline cable, comprising:
providing a core, the core comprising conductive strands and one or more layers of insulation disposed around the conductive strands;
stranding a first plurality of solid wires around the core of the conductive strands and the one or more layers of insulation to form an inner armor layer;
stranding a first plurality of stranded wires and a second plurality of solid wires around the inner armor layer in a single pass using a single preform head to form an outer armor layer; and
disposing a jacket around the inner armor layer and the outer armor layer.

2. The method of claim 1, wherein the jacket is disposed to completely surround the solid wires of the first plurality of stranded wires and the solid wires of the second plurality of solid wires, and the jacket is disposed to partially surround the solid wires of the first plurality of solid wires.

3. The method of claim 1, wherein one or more interstitial voids are formed, each interstitial void of the one or more interstitial voids being bounded by a portion of the jacket, a portion of the one or more layers of insulation, and two solid wires of the first plurality of solid wires.

4. The method of claim 1, wherein:
the jacket comprises a polymeric material;
the conductive strands of the core comprise a first metal; and
the first plurality of solid wires, the first plurality of stranded wires, and the second plurality of solid wires each comprise a second metal.

5. The method of claim 4, wherein:
the polymeric material of the jacket is carbon fiber filled ETFE;
the first metal of the conductive strands of the core is copper; and
the second metal is galvanized steel.

6. The method of claim 1, wherein the first plurality of stranded wires and the second plurality of solid wires are stranded around the circumference of the inner armor layer in an alternating arrangement.

7. A method of forming a hybrid wireline cable, comprising:
running a core through a preform head, the core comprising:
a plurality of conductive strands;
one or more layers of insulation disposed around the plurality of conductive strands; and
a first plurality of solid wires disposed around the plurality of conductive strands and the one or more layers of insulation to form an inner armor layer;
running a stranded wire of a first plurality of stranded wires through a first set of rollers coupled to the preform head;
running a solid wire of a second plurality of solid wires through a second set of rollers coupled to the preform head, wherein one of the first set of rollers or the second set of rollers comprises an offset roller;
stranding the first plurality of stranded wires and the second plurality of solid wires around the inner armor layer to form an outer armor layer; and
disposing a jacket around the inner armor layer and the outer armor layer.

8. The method of claim 7, wherein each of the first set of rollers and the second set of rollers comprises a first roller and a second roller, and the offset roller comprises a center that is offset from a linear direction extending between a center of the first roller and a center of the second roller of the respective first set of rollers or second set of rollers.

9. The method of claim 8, wherein the first set of rollers and the second set of rollers are sized to preform stranded wires, the second set of rollers includes the offset roller, and the first set of rollers includes a third roller disposed between the first roller and the second roller of the first set of rollers.

10. The method of claim 9, wherein the offset roller is offset from the first roller and the second roller of the second set of rollers by an offset angle, the offset angle being within a range of 1 degree to 9 degrees.

11. The method of claim 8, wherein the first set of rollers and the second set of rollers are sized to preform solid wires, the first set of rollers includes the offset roller, and the second set of rollers includes a third roller disposed between the first roller and the second roller of the first set of rollers.

12. The method of claim 11, wherein the offset roller is offset from the first roller and the second roller of the first set of rollers by an offset angle, the offset angle being within a range of 1 degree to 9 degrees.

13. The method of claim 7, wherein the first plurality of stranded wires and the second plurality of solid wires are stranded around the circumference of the inner armor layer in an alternating arrangement.

14. A method of forming a hybrid wireline cable, comprising:
running a core through a preform head, the core comprising:
a plurality of conductive strands;
one or more layers of insulation disposed around the plurality of conductive strands; and
a first plurality of solid wires disposed around the plurality of conductive strands and the one or more layers of insulation to form an inner armor layer;
running a stranded wire of a first plurality of stranded wires through a first set of rollers coupled to the preform head, each of the first set of rollers comprising a groove formed therein receiving the stranded wire and having a first diameter;
running a solid wire of a second plurality of solid wires through a second set of rollers coupled to the preform head, each of the second set of rollers comprising a groove formed therein receiving the solid wire and having a second diameter that is different than the first diameter;
stranding the first plurality of stranded wires and the second plurality of solid wires around the inner armor layer to form an outer armor layer; and
disposing a jacket around the inner armor layer and the outer armor layer.

15. The method of claim 14, wherein the second diameter of the groove formed in each of the second set of rollers that receives the solid wire is less than the first diameter.

16. The method of claim 15, wherein the second diameter is a ratio of the first diameter, the ratio being within a range of 0.6 to 0.8 of the first diameter.

17. The method of claim 14, wherein the first plurality of stranded wires and the second plurality of solid wires are stranded around the circumference of the inner armor layer in an alternating arrangement.
